(19) United States
(12) Patent Application Publication
(10) Pub. No.: US 2018/0032977 A1
(43) Pub. Date: Feb. 1, 2018

(54) METHOD AND SYSTEM FOR TRANSFERRING FUNDS FROM A SENDER ACCOUNT TO A RECEIVER ACCOUNT

(71) Applicant: MASTERCARD INTERNATIONAL INCORPORATED, Purchase, NY (US)

(72) Inventors: Varun Samel, Mumbai (IN); Aniket Nimkar, Pune (IN); Vaideeswaran Subramaniam, Pune (IN)

(21) Appl. No.: 15/657,560

(22) Filed: Jul. 24, 2017

(30) Foreign Application Priority Data
Jul. 26, 2016 (SG) 10201606177U

(51) Int. Cl. G06Q 20/10; G06Q 20/38

(52) U.S. Cl. CPC G06Q 20/10; G06Q 20/382; G06Q 20/327

(57) ABSTRACT

A method and system for transferring funds from a sender account to a receiver account, comprising: generating a token in one of a sender device or a receiver device, the token comprising data of either the sender account or the receiver account; transmitting, to the other of the sender device or the receiver device, the token for inclusion of data of the other of the sender account or the receiver account, wherein the transmission of the token occurs in response to the sender device being in proximity to the receiver device; including, into the token, data of the other of the sender account and the receiver account; and forwarding the token to a payment network system administering the transfer of funds from the sender account to the receiver account.

### TECHNICAL FIELD

The following discloses a method and server for transferring funds from a sender account to a receiver account.

### BACKGROUND

POS (point of sale) terminals provide a means to make electronic cash payment for a good or service provided by a merchant. While POS terminals may be commonplace in large department stores, small merchants may not have them as their profit margin may not justify the cost to implement and maintain POS terminals.

Further, POS terminals require customers to have payment cards, such as stored value cards, debit cards or credit cards, before they can be used to purchase a good or service provided by a merchant. Such payment cards have limitations which include topping up the stored value card when its stored value gets depleted or ensuring that the credit card limit is not exceeded. In addition, not all customers carry payment cards. These customers are not able to make electronic cash payment when purchasing goods or services and have to use physical cash.

The available electronic cash payment options between end users, such as through bank transfers, are also inconvenient in that a sender of the funds needs to locate an ATM (automated teller machine) or log into his internet banking account to perform the transfer. Both of these approaches requires the receiver to provide the sender with the receiver account details and the receiver may not be comfortable to provide such sensitive details to the sender.

There is thus a need to improve upon the several disadvantages associated with the above electronic payment means set out above.

### SUMMARY

According to a first aspect of the invention, there is provided a method for transferring funds from a sender account to a receiver account, the method comprising: generating a token in one of a sender device or a receiver device, the token comprising data of either the sender account or the receiver account; transmitting, to the other of the sender device or the receiver device, the token for inclusion of data of the other of the sender account or the receiver account, wherein the transmission of the token occurs in response to the sender device being in proximity to the receiver device; including, into the token, data of the other of the sender account and the receiver account; and forwarding the token to a payment network system administering the transfer of funds from the sender account to the receiver account.

According to a second aspect of the invention, there is provided a payment network system configured to administer the transfer of funds from a sender account to a receiver account, the payment network system comprising: at least one processor; and at least one memory including computer program code; the at least one memory and the computer program code configured to, with the at least one processor, cause the payment network system at least to: receive a token comprising data of the sender account and the receiver account; and route the transferred funds from the sender account to the receiver account, wherein the token originates from a token management application operating in either a sender device or a receiver device, the token management application requiring proximity between the sender device and the receiver device to generate the token.

According to a third aspect of the invention, there is provided a non-transitory computer readable medium having stored thereon a token management application for installation into a sender device and a receiver device, the token management application causing the sender device or the receiver device to perform steps comprising generating a token in one of a sender device or a receiver device, the token comprising data of either the sender account or the receiver account; transmitting, to the other of the sender device or the receiver device, the token for inclusion of data of the other of the sender account or the receiver account, wherein the transmission of the token occurs in response to the sender device being in proximity to the receiver device; including, into the token, data of the other of the sender account and the receiver account; and forwarding the token to a payment network system administering the transfer of funds from the sender account to the receiver account.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a schematic of a system in which funds are transferred, in accordance with one embodiment of the invention.

FIG. 2 shows a method, in accordance with one embodiment of the invention, which is implemented in the system of FIG. 1.

FIG. 3 shows a schematic of a computing device used to realise the payment network system shown in FIG. 1.

### DETAILED DESCRIPTION

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other computing device selectively activated or reconfigured by a computer program stored therein. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on a computer effectively results in an apparatus that implements the steps of the preferred method.

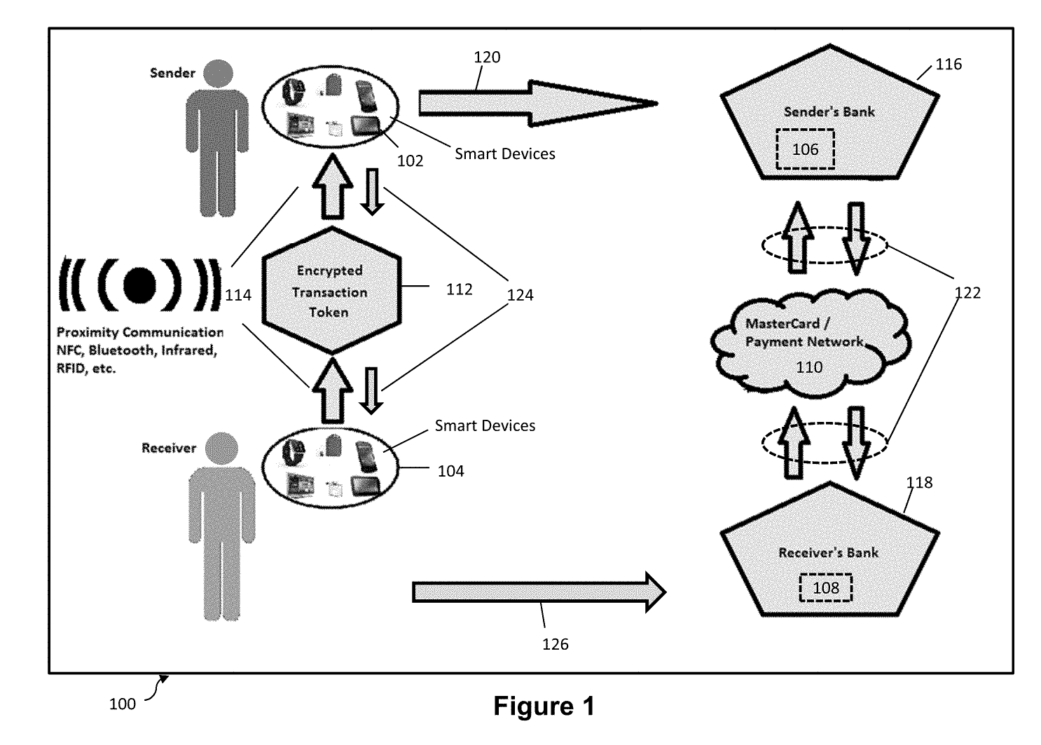

FIG. 1 shows a schematic of a system 100 in which funds are transferred, in accordance with one embodiment of the invention.

The system 100 comprises a sender device 102, a receiver device 104, a server 116 that administers a sender account 106, a server 118 that administers a receiver account 108 and a payment network system 110 that administers the transfer of funds from the sender account 106 to the receiver account 108.

The sender device 102 and the receiver device 104 may for example be a mobile terminal (such as a smart phone, a smart watch or a tablet) with an advanced mobile operating system, such as iOS of Apple Inc. or Android of Google Inc. The operating system may host one or more applications, where one or more of these applications is a token management application used to facilitate the transfer of funds from the sender account 106 to the receiver account 108.

The sender account 106 is a banking account to which the sender device 102 is linked, i.e. an account that the owner of the sender device 102 has opened with a financial institution. Accordingly, the server 116 that administers the sender account 106 may be part of a network of computer terminals that the financial institution uses to manage the sender account 106 and any accounts opened by other users that are not shown in FIG. 1. For the sake of simplicity, this server 116 may be interchangeably referred to as the “sender's bank”.

Similarly, the receiver account 108 is a banking account to which the receiver device 104 is linked, i.e. an account that the owner of the receiver device 104 has opened with a financial institution. Accordingly, the server 118 that administers the receiver account 108 may be part of a network of computer terminals that the financial institution uses to manage the receiver account 108 and any accounts opened by other users that are not shown in FIG. 1. For the sake of simplicity, this server 118 may be interchangeably referred to as the “receiver's bank”.

The payment network system 110 that administers the transfer of funds from the sender account 106 to the receiver account 108 refers to a network of computers that are tapped upon when making electronic transfer of funds from the sender account 106 to the receiver account 108 or when making electronic payment using a payment instrument. The network of computers may thus include computer systems used to implement the four party model used by Visa® or MasterCard® to process a payment transaction made using their card. The notable components of the payment network thus include an acquirer, an issuer and a switch that routes information between the acquirer and the issuer. In the present disclosure, it is the switching function of the payment network system 110 that is harnessed and used to route funds transferred from the sender account 106 to the receiver account 108.

Before the system 100 can be used to effect fund transfer from the sender account 106 to the receiver account 108, a token management application has to be installed in both the sender device 102 and the receiver device 104. The token management application initiates the creation of tokens that subsequently flow between the various components of the system 100. Each of the sender device 102 and the receiver device 104 may obtain the token management application through an application repository such as the Apple Inc. application store or the Google Inc. play store. In one implementation, the tokens that are transmitted between the sender device 102 and the receiver device 104 have data formats that are compatible with various operating systems. Accordingly, the token management application installed in the sender device 102 may be different from the token management application installed in the receiver device 104, such as if the sender device 102 uses the iOS operating system and the receiver device 104 uses the Android operating system. The token management application installed in both the sender device 102 and the receiver device 104 would still be able to process the received tokens.

After the token management application is installed in the sender device 102, the sender device 102 may be linked to the sender account 106 maintained by the server 116 (i.e. the sender's bank) through the token management application. This linkage may be done, for example, by registering details of the sender device 102 with an input portal hosted by the server 106. Similarly, after the token management application is installed in the receiver device 104, the receiver device 104 may be linked to the receiver account 108 maintained by the server 118 (i.e. the receiver's bank). This linkage may be done, for example, by registering details of the receiver device 104 with an input portal hosted by the server 118. The sender device 102 may be linked to more than one sender account maintained by the server 116 or each maintained in different servers (not shown). Similarly, the receiver device 104 may be linked to more than one receiver account maintained by the server 118 or each maintained in different servers (not shown).

Data that allows the identification of the linked sender accounts and the linked receiver accounts is stored in one or more tokens at the sender device 102 and the receiver device 104 respectively. For example, there may be one token for each of the linked sender accounts at the sender device 102 and one token for each of the linked receiver accounts at the receiver device 104. In one approach, the token is created at the sender device 102 when the sender device 102 is linked to the sender account 106 or at the receiver device 104 when the receiver device 104 is linked to the receiver account 108 for use when funds are to be transferred. In another approach, the token is created only when funds are to be transferred from the sender account 106 to the receiver account 108. The data that allows the identification of the linked sender accounts and linked receiver accounts can be retrieved from a data cloud by the sender device 102 and the receiver device 104 respectively, for inclusion into one or more tokens at the sender device 102 and the receiver device 104 respectively. The data cloud may be administrated by the payment network 110 or be independently managed. Alternatively, the data that allows the identification of the linked sender accounts and linked receiver accounts can be stored directly in the token management application installed in the sender device 102 and the receiver device 104 respectively.

In a first implementation, it is the receiver device 104 that initiates the process that allows the transfer of funds from the sender account 106 to the receiver account 108. During this process, the receiver device 104 transmits 114 a token 112 to the sender device 102. This token 112 contains data of the receiver account 108, i.e. data that allows identification of the receiver account 108 as the destination of the funds for the fund transfer. This data can be retrieved from the data cloud by the receiver device 104 or directly retrieved from the token management application installed in the receiver device 104, for inclusion into the token 112.

Upon receipt of the token 112, the sender device 102 includes into the token 112 data of the sender account 106, i.e. data that allows identification of the sender account 106 as the source of the funds for the fund transfer. This data can be retrieved from the data cloud by the sender device 102 or directly retrieved from the token management application installed in the sender device 102, for inclusion into the token 112. The token 112 is then forwarded 120 to the payment network system 110. In the system 100, the token 112 is forwarded 120 to the payment network system 110 by the server 116. Accordingly, when the token 112 is received by the payment network system 110, the token 112 contains data of both the sender account 106 and the receiver account 108. The payment network system 110 is then able to route 122 the transferred funds from the sender account 106 to the receiver account 118.

The token 112 may be processed in both the sender device 102 and the receiver device 104 by the token management application installed in both the sender device 102 and the receiver device 104. For example, the token management application installed in the receiver device 104 generates the token 112 for transmission to the sender device 102. The token management application installed in the sender device 102 may then receive the token 112 for the inclusion of the data of the sender account 106 and forward the token 112 to the payment network system 110.

Further, the transmission 114 of the token 112 occurs in response to the sender device 102 being in proximity to the receiver device 104. The transmission 114 of the token 112 may occur after the token management application is activated in both the sender device 102 and the receiver device 104.

An indication of an amount of the funds to be transferred from the sender account 106 to the receiver account 108 may be included into the token 112 by the receiver device 104 before the receiver device 104 transmits the token 112 to the sender device 102. For instance, this indication may be included during generation of the token 112 by the receiver device 104. Alternatively, this indication of the amount of the transferred funds may be included into the token 112 by the sender device 102 before the sender device 102 forwards the token 112 to the payment network system 110.

In a second implementation, it is the sender device 102 that initiates the process that allows the transfer of funds from the sender account 106 to the receiver account 108. During this process, the sender device 102 transmits 124 a token 112 to the receiver device 104. This token 112 contains data of the sender account 106, i.e. data that allows identification of the the sender account 106 as the source of the funds for the fund transfer. This data can be retrieved from the data cloud by the sender device 102 or directly retrieved from the token management application installed in the sender device 102, for inclusion into the token 112.

Upon receipt of the token 112, the receiver device 104 includes into the token 112 data of the receiver account 108, i.e. data that allows identification of the receiver account 108 as the destination of the funds for the fund transfer. This data can be retrieved from the data cloud by the receiver device 104 or directly retrieved from the token management application installed in the receiver device 104, for inclusion into the token 112. The token 112 is then forwarded 126 to the payment network system 110. In the system 100, the token 112 is forwarded 126 to the payment network system 110 by the server 118. Accordingly, when the token 112 is received by the payment network system 110, the token 112 contains data of both the sender account 106 and the receiver account 108. The payment network system 110 is then able to route 122 the transferred funds from the sender account 106 to the receiver account 118.

The token 112 may be processed in both the sender device 102 and the receiver device 104 by the token management application installed in both the sender device 102 and the receiver device 104. For example, the token management application installed in the sender device 102 generates the token 112 for transmission to the receiver device 104. The token management application installed in the receiver device 104 may then receive the token 112 for the inclusion of the data of the receiver account 108 and forward the token 112 to the payment network system 110.

Further, the transmission 124 of the token 112 occurs in response to the sender device 102 being in proximity to the receiver device 104. The transmission 114 of the token 112 may occur after the token management application is activated in both the sender device 102 and the receiver device 104.

An indication of an amount of the funds to be transferred from the sender account 106 to the receiver account 108 may be included into the token 112 by the sender device 102 before the sender device 102 transmits the token 112 to the receiver device 104. For instance, this indication may be included during generation of the token 112 by the sender device 102. Alternatively, this indication of the amount of the transferred funds may be included into the token 112 by the receiver device 104 before the receiver device 104 forwards the token 112 to the payment network system 110.

The token created by the token management application thus provides a means for bank account numbers to be exchanged between the sender device 102 and the receiver device 104, wherein the exchanged account numbers are not externally revealed to the sender or the receiver. The fund transfer is done conveniently, since all that is required is for the sender device 102 and the receiver device 104 to be in proximity, and for the token management application to be activated. The backend processing of the token which occurs at the payment network system 110 then allows for a direct account to account transfer, without the need for a digital wallet application installed in either or both of the sender device 102 and the receiver device 104. Further, the system 100 is implementable by generic smart devices, providing merchants with an additional mode of electronic payment to their clients. Moreover, as a POS (point of sale) terminal is not required to implement the system 100, the system 100 is accessible to merchants which do not use POS terminals. The system 100 also finds application beyond the customer and a merchant context and allows for any two parties to transfer money to each other, as long as each party has a smart device.

Any one or more of the following wireless technologies may be used to transmit the token between the sender device 102 and the receiver device 104: near field communication (NFC) or Bluetooth. The proximity in which the sender device 102 and the receiver device 104 are to be placed thus depends on the range over which these wireless technologies transmit data.

In both of the above first and second implementations, approval is sought from the sender device 102 before routing 122 the transferred funds from the sender account 106 to the receiver account 108. Both the sender device 102 and the receiver device 104 may also receive confirmation of the fund transfer from the sender account 106 to the receiver account 108. The token 112 may also be encrypted to provide an additional measure of security.

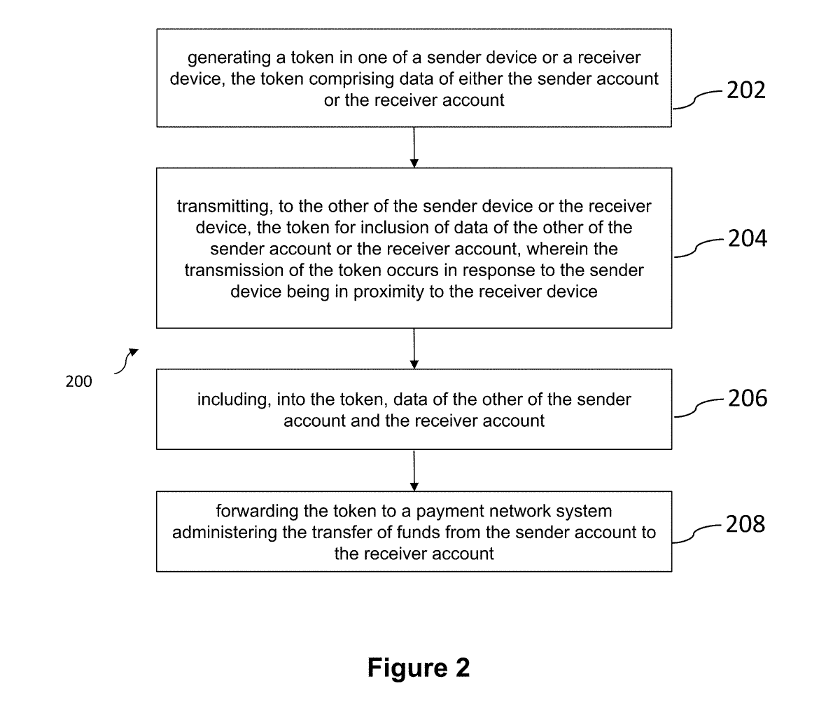

FIG. 2 shows a method, in accordance with one embodiment of the invention, which is implemented in the system 100 of FIG. 1.

The method of FIG. 2 uses a process 200 that includes the steps 202, 204, 206 and 208. The process 200 is described with reference to the system 100 as described above in respect of FIG. 1.

As mentioned above, with respect to the system 100 of FIG. 1, the token 112 can be generated by either of the sender device 102 or the receiver device 104. If the first implementation is adopted, it is the receiver device 104 that generates the token 112, whereby the token 112 contains data of the receiver account 108. If the second implementation is adopted, it is the sender device 102 that generates the token 112, whereby the token 112 contains data of the sender account 106. Thus, in step 202, a token 112 is generated in one of a sender device 102 or a receiver device 104, the token 112 comprising data of either the sender account 106 or the receiver account 108.

In the first implementation, the receiver device 104 transmits the token 112 to the sender device 102. The token 112 is transmitted to the sender device 102 so that the sender device 102 can include data of the sender account 106 into the token 112. This data can be retrieved from the data cloud by the receiver device 104 or directly retrieved from the token management application installed in the receiver device 104, for inclusion into the token 112. Similarly, in the second implementation, the sender device 102 transmits the token 112 to the receiver device 104 so that the receiver device 104 can include data of the receiver account 108 into the token 112. Likewise, this data can be retrieved from the data cloud by the sender device 102 or directly retrieved from the token management application installed in the sender device 102, for inclusion into the token 112. Thus, in step 204, the token 112 is transmitted to the other of the sender device 102 or the receiver device 104, for inclusion of data of the other of the sender account 106 or the receiver account 108. Transmission of the token 112 occurs in response to the sender device 102 being in proximity to the receiver device 104. The transmission of the token 112 may also occur after a token management application is activated in both the sender device 102 and the receiver device 104. The token management application installed in the sender device 102 may be different from the token management application installed in the receiver device 104. The token management application may be downloaded from an application repository.

In step 206, data of the other of the sender account 106 and the receiver account 108 is included into the token 112. This data may be retrieved from the data cloud by the other of the sender account 106 and the receiver account 108 respectively, or directly retrieved from the token management application installed in the other of the sender account 106 and receiver account 108 respectively.

In step 208, the token 112 is forwarded to a payment network system 110 administering the transfer of funds from the sender account 106 to the receiver account 108.

To realise the first implementation of the system 100, steps 202, 204 and 206 have the token 112 generated at the receiver device 104 to have data of the receiver account 108. This data may be retrieved from the data cloud by the receiver device 104 or directly retrieved from the token management application installed in the receiver device 104. The token 112 is transmitted to the sender device 102, where the sender device 102 includes data of the sender account 106 into the token 112. This data may be retrieved from the data cloud by the sender device 102 or directly retrieved from the token management application installed in the sender device 102, before forwarding the token 112 to the payment network system 110.

To realise the second implementation of the system 100, steps 202, 204 and 206 have the token 112 generated at the sender device 102 to have data of the sender account 106. This data may be retrieved from the data cloud by the sender device 102 or directly retrieved from the token management application installed in the sender device 102. The token 112 is transmitted to the receiver device 104, where the receiver device 104 includes data of the receiver account 108 into the token 112. This data may be retrieved from the data cloud by the receiver device 104 or directly retrieved from the token management application installed in the receiver device 104, before forwarding the token 112 to the payment network system 110.

The token 112 forwarded to the payment network system 110 may include an indication of an amount of the funds to be transferred from the sender account 106 to the receiver account 108. The indication of the transferred funds amount may be included into the token during generation of the token which occurs in the step 202. Alternatively, this indication may be included before forwarding of the token to the payment network system, such as in the step 206.

As described in FIG. 1, the token 112 may be forwarded to the payment network system by a server 116, 118 administering either of the sender account 106 or the receiver account 108. This server 116, 118 first receives the token 112 from the sender device 102 or the receiver device 104, respectively. For instance, in the first implementation, the token 112 is forwarded to the server 116 that administers the sender account 106. In the second implementation, the token 112 is forwarded to the server 118 that administers the receiver account 108.

After the token 112 is forwarded to the payment network system 110, approval from the sender device 102 for the fund transfer may be sought before the funds are transferred from the sender account 106 to the receiver account 108. In addition, after the funds transfer, both the sender device 102 and the receiver device 104 may receive confirmation. The token 112 may be encrypted.

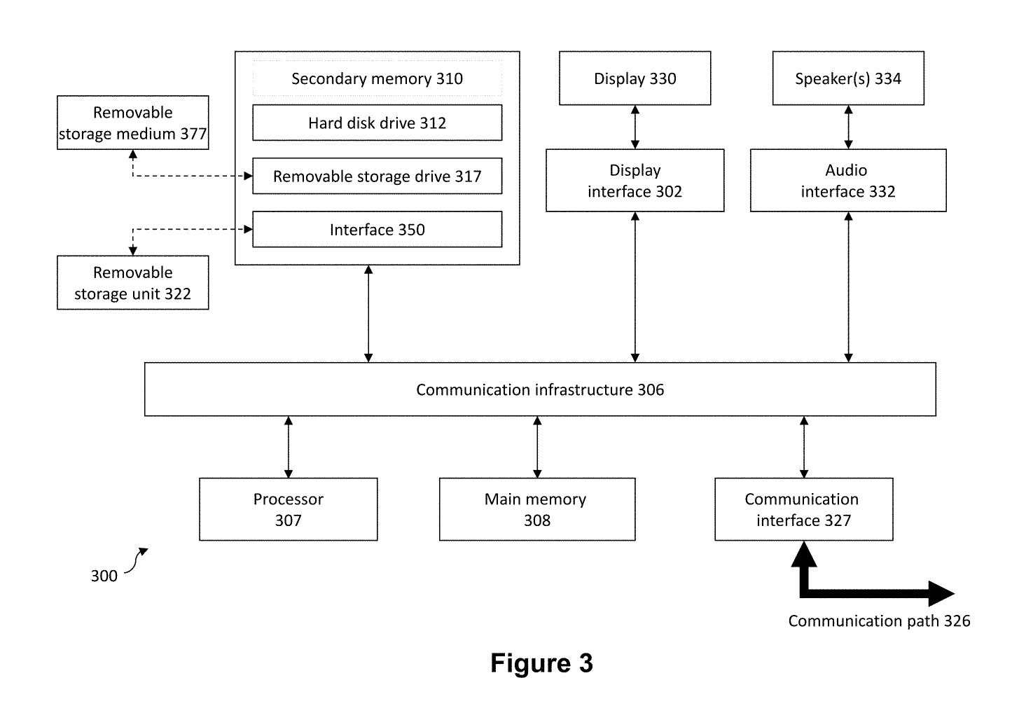

FIG. 3 depicts an exemplary computing device 300, hereinafter interchangeably referred to as a computer system 300, where one or more such computing devices 300 may be used to execute the method of FIG. 2. The exemplary computing device 300 can be used to implement the payment network system 110 shown in FIG. 1. The following description of the computing device 300 is provided by way of example only and is not intended to be limiting.

As shown in FIG. 3, the example computing device 300 includes a processor 307 for executing software routines. Although a single processor is shown for the sake of clarity, the computing device 300 may also include a multi-processor system. The processor 307 is connected to a communication infrastructure 306 for communication with other components of the computing device 300. The communication infrastructure 306 may include, for example, a communications bus, cross-bar, or network.3

The computing device 300 further includes a main memory 308, such as a random access memory (RAM), and a secondary memory 310. The secondary memory 310 may include, for example, a storage drive 312, which may be a hard disk drive, a solid state drive or a hybrid drive and/or a removable storage drive 317, which may include a magnetic tape drive, an optical disk drive, a solid state storage drive (such as a USB flash drive, a flash memory device, a solid state drive or a memory card), or the like. The removable storage drive 317 reads from and/or writes to a removable storage medium 377 in a well-known manner. The removable storage medium 377 may include magnetic tape, optical disk, non-volatile memory storage medium, or the like, which is read by and written to by removable storage drive 317. As will be appreciated by persons skilled in the relevant art(s), the removable storage medium 377 includes a computer readable storage medium having stored therein computer executable program code instructions and/or data.

In an alternative implementation, the secondary memory 310 may additionally or alternatively include other similar means for allowing computer programs or other instructions to be loaded into the computing device 300. Such means can include, for example, a removable storage unit 322 and an interface 350. Examples of a removable storage unit 322 and interface 350 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 322 and interfaces 350 which allow software and data to be transferred from the removable storage unit 322 to the computer system 300.

The computing device 300 also includes at least one communication interface 327. The communication interface 327 allows software and data to be transferred between computing device 300 and external devices via a communication path 326. In various embodiments of the inventions, the communication interface 327 permits data to be transferred between the computing device 300 and a data communication network, such as a public data or private data communication network. The communication interface 327 may be used to exchange data between different computing devices 300 which such computing devices 300 form part an interconnected computer network. Examples of a communication interface 327 can include a modem, a network interface (such as an Ethernet card), a communication port (such as a serial, parallel, printer, GPIB, IEEE 1394, RJ45, USB), an antenna with associated circuitry and the like. The communication interface 327 may be wired or may be wireless. Software and data transferred via the communication interface 327 are in the form of signals which can be electronic, electromagnetic, optical or other signals capable of being received by communication interface 327. These signals are provided to the communication interface via the communication path 326.

As shown in FIG. 3, the computing device 300 further includes a display interface 302 which performs operations for rendering images to an associated display 330 and an audio interface 332 for performing operations for playing audio content via associated speaker(s) 337.

As used herein, the term “computer program product” may refer, in part, to removable storage medium 377, removable storage unit 322, a hard disk installed in storage drive 312, or a carrier wave carrying software over communication path 326 (wireless link or cable) to communication interface 327. Computer readable storage media refers to any non-transitory, non-volatile tangible storage medium that provides recorded instructions and/or data to the computing device 300 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 300. Examples of transitory or non-tangible computer readable transmission media that may also participate in the provision of software, application programs, instructions and/or data to the computing device 300 include radio or infra-red transmission channels as well as a network connection to another computer or networked device, and the Internet or Intranets including e-mail transmissions and information recorded on Websites and the like.

The computer programs (also called computer program code) are stored in main memory 308 and/or secondary memory 310. Computer programs can also be received via the communication interface 327. Such computer programs, when executed, enable the computing device 300 to perform one or more features of embodiments discussed herein. In various embodiments, the computer programs, when executed, enable the processor 307 to perform features of the above-described embodiments. Accordingly, such computer programs represent controllers of the computer system 300.

Software may be stored in a computer program product and loaded into the computing device 300 using the removable storage drive 317, the storage drive 312, or the interface 350. The computer program product may be a non-transitory computer readable medium. Alternatively, the computer program product may be downloaded to the computer system 300 over the communications path 326. The software, when executed by the processor 307, causes the computing device 300 to perform the necessary operations to execute the method 100 as shown in FIG. 1.

It is to be understood that the embodiment of FIG. 3 is presented merely by way of example to explain the operation and structure of the network switch 202. Therefore, in some embodiments one or more features of the computing device 300 may be omitted. Also, in some embodiments, one or more features of the computing device 300 may be combined together. Additionally, in some embodiments, one or more features of the computing device 300 may be split into one or more component parts.

When used to realise the payment network system 110 of FIG. 1, the processor 307 and computer program code stored in the memory 308 are configured to cause the payment network system 110 to receive an indication of the beneficiary account to which a monetary amount is to be credited. The processor 307 and computer program code stored in the memory 308 are further configured to cause the payment network system 110 to receive a token 112 comprising data of the sender account 106 and the receiver account 108. The processor 307 and computer program code stored in the memory 308 are further configured to cause the payment network system 110 to route the transferred funds from the sender account 106 to the receiver account 108. The token 112 originates from a token management application operating in either a sender device 102 or a receiver device 104, the token management application requiring proximity between the sender device 102 and the receiver device 104 to generate the token 112. Generation of the token 112 may occur when a token management application is activated in both the sender device 102 and the receiver device 104.

The token 112 may be received from a server 116, 118 administering either of the sender account 106 or the receiver account 108, the server 116, 118 having received the token 112 from the sender device 102 or the receiver device 104, respectively.

The payment network system 110 may be further configured to receive approval from the sender device 102 for the fund transfer before routing 122 the transferred funds from the sender account 106 to the receiver account 108.

The payment network system 110 may also be further configured to transmit to both the sender device 102 and the receiver device 104 confirmation of the fund transfer from the sender account to the receiver account.

As mentioned above, the token management application which facilitates the creation of the token 112 may be downloaded from an application repository. The application repository will have a non-transitory computer readable medium stored thereon the token management application for installation into a sender device 102 and a receiver device 104 (i.e. the non-transitory computer readable medium stores the token management application in an uncompiled state). Upon installation, the token management application causes the sender device 102 or the receiver device 104 to perform steps comprising a) generating a token 112 in one of a sender device 102 or a receiver device 104, the token comprising data of either the sender account 106 or the receiver account 108; and b) transmitting, to the other of the sender device 102 or the receiver device 104, the token 112 for inclusion of data of the other of the sender account 106 or the receiver account 108. Transmission of the token 112 occurs in response to the sender device 102 being in proximity to the receiver device 104. The further steps are: c) including, into the token 112, data of the other of the sender account 106 and the receiver account 108; and forwarding the token 112 to a payment network system 110 administering the transfer of funds from the sender account 106 to the receiver account 108.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A computer-implemented method for transferring funds from a sender account to a receiver account, the method comprising:
generating a token in one of a sender device or a receiver device, the token comprising data of either the sender account or the receiver account;
transmitting, to the other of the sender device or the receiver device, the token for inclusion of data of the other of the sender account or the receiver account, wherein the transmission of the token occurs in response to the sender device being in proximity to the receiver device;
including, into the token, data of the other of the sender account and the receiver account; and
forwarding the token to a payment network system administering the transfer of funds from the sender account to the receiver account.

2. The computer-implemented method of claim 1, wherein transmission of the token occurs after a token management application is activated in both the sender device and the receiver device.

3. The computer-implemented method of claim 1, wherein the token is generated at the receiver device to have data of the receiver account and the token is transmitted to the sender device, where the sender device includes data of the sender account into the token before forwarding the token to the payment network system.

4. The computer-implemented method of claim 1, wherein the token is generated at the sender device to have data of the sender account and the token is transmitted to the receiver device, where the receiver device includes data of the receiver account into the token before forwarding the token to the payment network system.

5. The computer-implemented method of claim 1, wherein the token forwarded to the payment network system comprises an indication of an amount of the funds to be transferred from the sender account to the receiver account, the indication of the transferred funds amount being included into the token during generation of the token or before forwarding of the token to the payment network system.

6. The computer-implemented method of claim 1, wherein the token is forwarded to the payment network system by a server administering either of the sender account or the receiver account, the server having received the token from the sender device or the receiver device, respectively.

7. The computer-implemented method of claim 1, further comprising:
receiving approval from the sender device for the fund transfer before the funds are transferred from the sender account to the receiver account.

8. The computer-implemented method of claim 1, further comprising:
receiving, in both the sender device and the receiver device, confirmation of the fund transfer from the sender account to the receiver account.

9. The computer-implemented method of claim 1, wherein the token is encrypted.

10. The computer-implemented method of claim 2, wherein the token management application installed in the sender device is different from the token management application installed in the receiver device.

11. The computer-implemented method of claim 2, wherein the token management application is downloaded from an application repository.

12. A payment network system configured to administer the transfer of funds from a sender account to a receiver account, the payment network system comprising:
at least one processor; and
at least one non-transitory memory including computer program code;
the at least one memory and the computer program code configured to, with the at least one processor, cause the payment network system at least to:
receive a token comprising data of the sender account and the receiver account; and
route the transferred funds from the sender account to the receiver account,
wherein the token originates from a token management application operating in either a sender device or a receiver device, the token management application requiring proximity between the sender device and the receiver device to generate the token.

13. The payment network system of claim 12, wherein generation of the token occurs when a token management application is activated in both the sender device and the receiver device.

14. The payment network system of claim 12, wherein the token is received from a server administering either of the sender account or the receiver account, the server having received the token from the sender device or the receiver device, respectively.

15. The payment network system of claim 12, wherein the payment network system is further configured to receive approval from the sender device for the fund transfer before routing the transferred funds from the sender account to the receiver account.

16. The payment network system of claim 12, wherein the payment network system is further configured to transmit to both the sender device and the receiver device confirmation of the fund transfer from the sender account to the receiver account.

17. A non-transitory computer readable medium having stored thereon a token management application for installation into a sender device and a receiver device, the token management application causing the sender device or the receiver device to perform steps comprising:
generating a token in one of a sender device or a receiver device, the token comprising data of either the sender account or the receiver account;
transmitting, to the other of the sender device or the receiver device, the token for inclusion of data of the other of the sender account or the receiver account, wherein the transmission of the token occurs in response to the sender device being in proximity to the receiver device;
including, into the token, data of the other of the sender account and the receiver account; and
forwarding the token to a payment network system administering the transfer of funds from the sender account to the receiver account.
